(19) United States
(12) Patent Application Publication
(10) Pub. No.: US 2015/0028823 A1
(43) Pub. Date: Jan. 29, 2015

(54) PULSE WIDTH MODULATED POWER REGULATOR WITH LOOP STABILIZER

(71) Applicants: Dan LI, Shanghai (CN); Jinhua NI, Shanghai (CN)

(72) Inventors: Dan LI, Shanghai (CN); Jinhua NI, Shanghai (CN)

(73) Assignee: ANALOG DEVICES TECHNOLOGY, Hamilton (BM)

(21) Appl. No.: 13/949,776

(22) Filed: Jul. 24, 2013

(51) Int. Cl. G05F 1/66

(52) U.S. Cl. CPC G05F 1/66
USPC 323/234

(57) ABSTRACT

A circuit may include a detector, a modulator, a switch, and a stabilizer. The detector may detect current supplied to an output of the circuit to generate an overcurrent signal. The modulator may modulate a pulse signal based upon the output of the circuit. The switch may control a power stage to generate the output of the circuit based upon the overcurrent signal and the pulse signal. The stabilizer may send an offset signal to the modulator. The stabilizer may generate the offset signal with a magnitude adjusted based upon the overcurrent signal, and the modulator may adjust the pulse signal based upon the offset signal.

### BACKGROUND

Power regulators controlled by pulse width modulation may be used to supply power in various systems and devices. A power regulator may sense its output voltage and/or current and modulate the pulses in a control signal to switch the power supply to the output on and off. By adjusting the amount of time the power supply is switched on relative to the amount of time the power supply is switched off, the power regulator may maintain the output voltage and/or current to be close to designated level.

If the output current drawn by a load increases rapidly, the power regulator may sense the increase in current and increase the on time for the control signal. However, if the change in current is too rapid, the power regulator may be clamped to its sensing limit and force its control signal to the limit of pulse modulation. Subsequently, if the output current decreases rapidly, the power regulator may overcompensate and cause the output to overshoot the intended output voltage and/or current level.

Accordingly, there is a need for a pulse modulated power regulator having increased feedback loop stability and less overshoot during response.

### BRIEF DESCRIPTION OF THE DRAWINGS

FIG. 1 illustrates a circuit according to an embodiment of the present disclosure.

FIG. 2 illustrates an exemplary simulated timing diagram of signals of a circuit according to an embodiment of the present disclosure.

FIG. 3 illustrates a circuit according to an embodiment of the present disclosure.

FIG. 4 illustrates an exemplary simulated timing diagram of signals of a circuit according to an embodiment of the present disclosure.

FIG. 5 illustrates a stabilizer according to an embodiment of the present disclosure.

FIG. 6 illustrates a stabilizer according to an embodiment of the present disclosure.

FIG. 7 illustrates a method according to an embodiment of the present disclosure.

### DETAILED DESCRIPTION

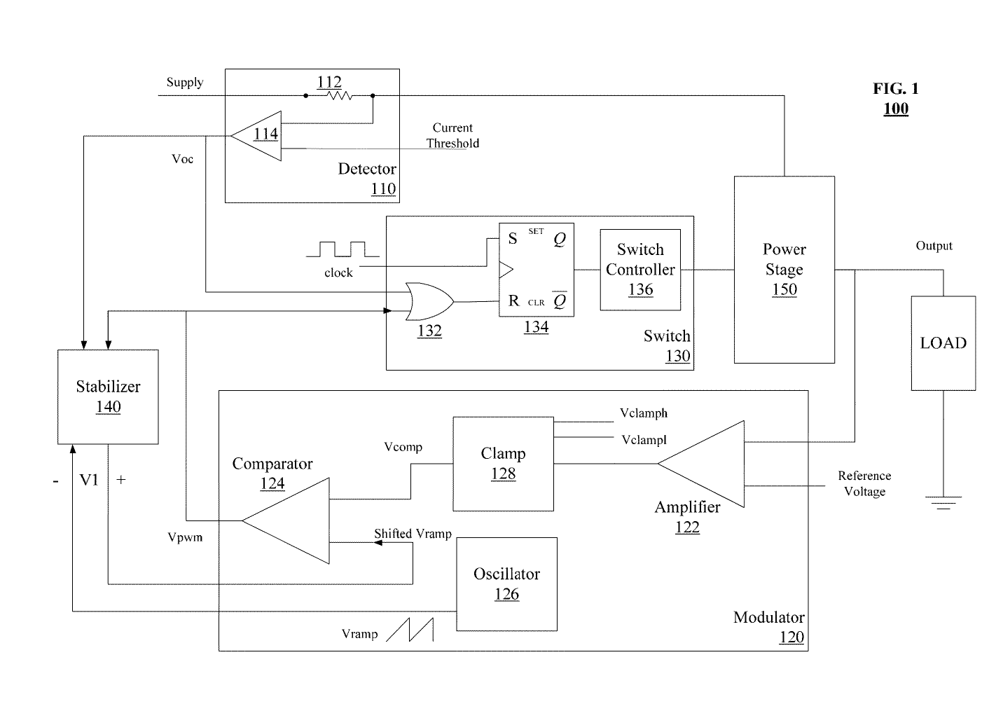

According to an embodiment illustrated in FIG. 1, a circuit 100 may include a detector 110, a modulator 120, a switch 130, and a stabilizer 140. The detector 110 may detect current supplied to an output of the circuit 100 to generate an overcurrent signal. The modulator 120 may modulate a pulse signal based upon the output of the circuit 100. The switch 130 may control a power stage 150 to generate the output of the circuit 100 based upon the overcurrent signal and the pulse signal. The stabilizer 140 may send an offset signal to the modulator 120. The stabilizer 140 may generate the offset signal with a magnitude adjusted based upon the overcurrent signal, and the modulator 120 may adjust the pulse signal based upon the offset signal.

The detector 110 may include a current sensing resistor 112 and an overcurrent comparator 114 that generates the overcurrent signal (Voc) based upon comparison of a signal from the current sensing resistor 112 and a current threshold.

The modulator 120 may include an amplifier 122 that generates an error signal (Vcomp) based upon difference between the output (Output Voltage) of the circuit and an output threshold (Reference Voltage), and a comparator 124 that generates the pulse signal (Vpwm) by comparing the error signal (Vcomp) and an oscillating signal (Vramp). The modulator 120 may include an oscillator 126 that generates the oscillating signal (Vramp), and a clamp 128 that clamps the error signal between a high and a low clamping level (Vclamph and Vclampl respectively). The oscillating signal from the oscillator 126 may have a sawtooth waveform, a triangular waveform.

The switch 130 may receive the overcurrent signal from the detector 110 and the pulse signal from the modulator 120, and may include a NOR gate 132, a flip-flop 134, and a switching controller 136 to control the power stage 150. The power stage 150 may be controlled by the switch 130, via pulse width modulated (PWM), to channel power from a power supply to generate the output for the circuit 100. That is, the power stage 150 may turn the power supply to the output on and off rapidly, and depending on the amount of time that the power supply was on, cause adjustment the output voltage and current. The power stage 150 may include a plurality of gates or switches, capacitors, resistors, inductors, etc. (not shown).

The stabilizer 140 may receive the overcurrent signal and the pulse signal, and may adjust the magnitude of the offset signal as proportional to a value from the counter representing the activities of the overcurrent signal. The stabilizer 140 may adjust the magnitude of the offset signal by measuring the overcurrent signal.

In an embodiment, the oscillating signal may be generated with a DC offset level based upon the offset signal, and the modulator adjusts the pulse signal by comparing the oscillating signal to an error signal. As illustrated in FIG. 1, the stabilizer 140 may be connected to the oscillator 126 to generate the oscillating signal that includes the DC offset level. That is, the stabilizer 140 may receive the oscillating signal (Vramp) from the oscillator 126 and add the offset signal (V1) to the oscillating signal (Vramp) to generate a shifted oscillating signal (Shifted Vramp) that shifts its values according to the offset signal.

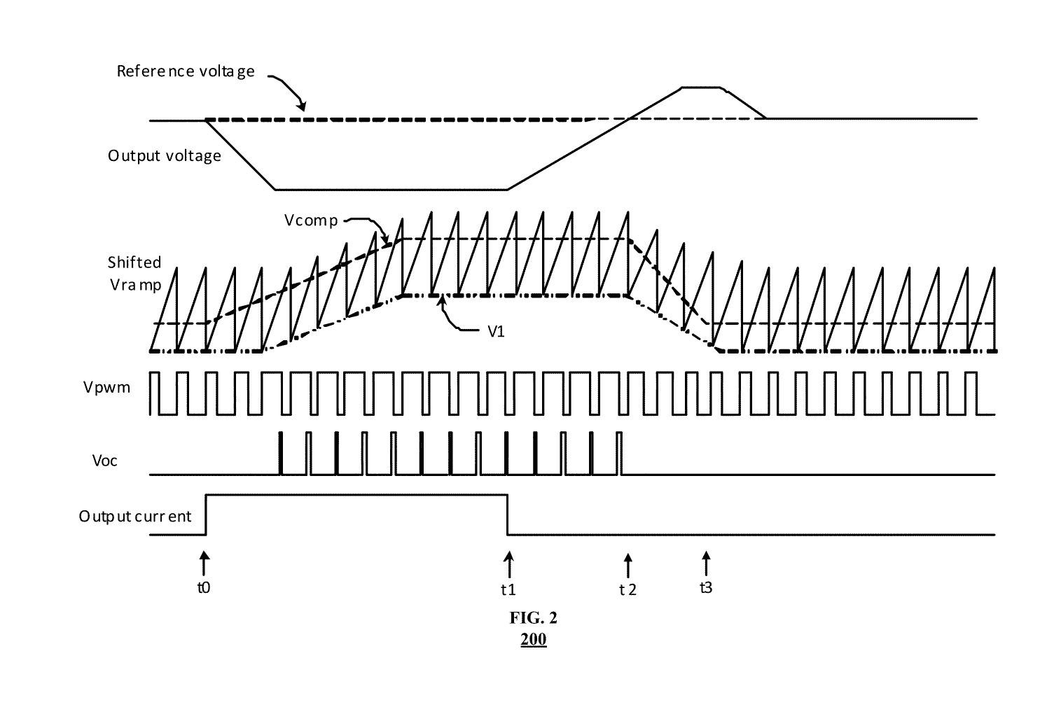

As illustrated in FIG. 2, the offset signal (V1) may be added with the Vramp signal. This may make the Shifted Vramp signal track with the Vcomp signal, when Vcomp is going high during large output current drawn.

As shown in FIG. 2, when large output current is drawn at time t0, the Vcomp signal may rise up relative to Shifted Vramp signal, which at time t0 does not have any offset. As Vcomp rises, the comparator 124 in modulator 120 may increase the duty cycle of the pulse signal (Vpwm). The switch 130 may control the power stage 150 to provide more power to the output in each cycle. After some delay time, the detector 110 may detect that the current supplied to the output is above the current threshold, and the detector 110 may output the overcurrent signal (Voc) to be high. Shortly after, as the power stage 150 is turned off in a cycle, Voc may return to low.

As the pulse signal (Vpwm) increases in duty cycle, more current may be supplied to the output and Voc becomes activated in each cycle. The stabilizer 140 may measure Voc and increase the magnitude of the offset signal (V1) proportional to the activity of Voc. For example, more Voc high state in a previous period of time, the higher V1 may be adjusted to. The Shifted Vramp signal may shift according to V1 and rise up and track the Vcomp signal to prevent Vcomp from rising above the peak value of Shift Vramp signal. This may allow the duty cycle of Vpwm to increase as needed, but prevents the overcurrent condition from causing the duty cycle to max out. In steady state, even if the output voltage has already been pulled down below the reference voltage, the duty cycle of Vpwm may be kept at some stable level to make the supply current equal to the current threshold. Thus, the PWM loop of circuit 100 may still be stable at overcurrent condition, even if the output voltage is no longer regulated to desired level.

As illustrated in FIG. 2, when the output current decreases to small value at time t1, the output voltage may begin to rise. When the output voltage is higher than the reference voltage after time t2, the Vcomp signal start to decrease relative to the Shifted Vramp signal, causing Vpwm to reduce in duty cycle. As supply current is decreased, Voc signal stop activating. The stabilizer 140 may reduce the magnitude of the offset signal (V1) according to decrease in Voc signal activities. The Shifted Vramp signal may decrease in its offset and track with the Vcomp signal. When the Vcomp signal goes back to the original value at t3, the duty cycle of Vpwm may stabilize at some minimum level.

Because of the stabilizer 140, the duty cycle of Vpwm may start to decrease from t2. The circuit 100 may recover from an overcurrent condition quickly. Therefore, the stabilizer 140 in circuit 100 may reduce the over shoot voltage at output.

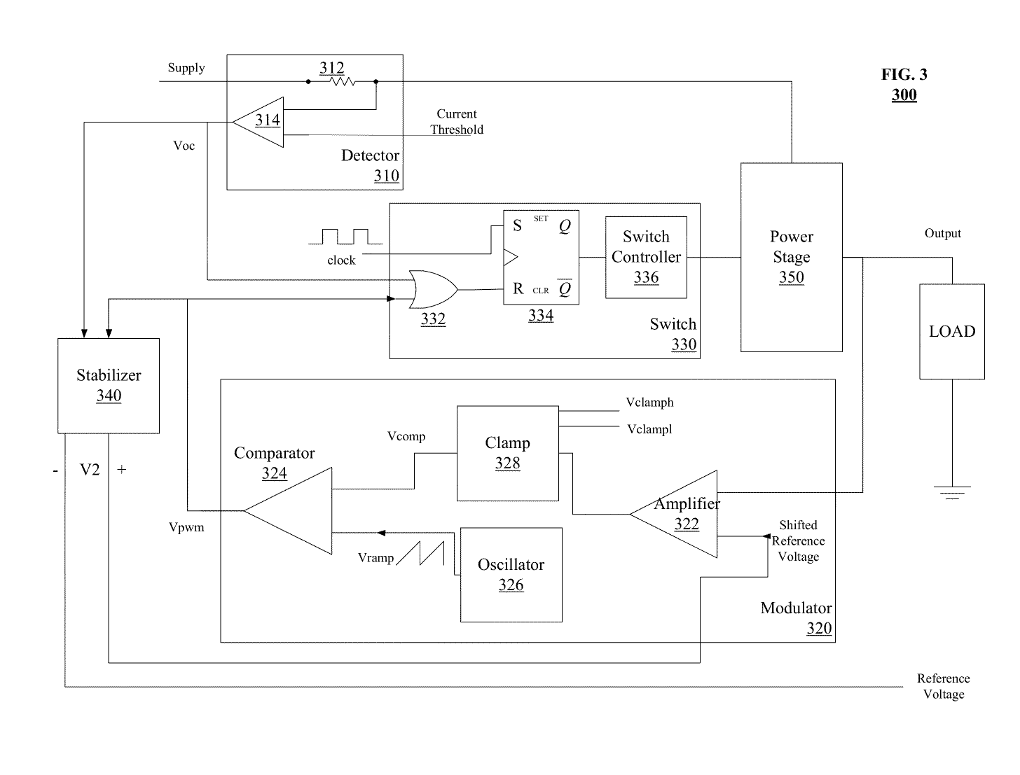

In an alternative embodiment, the error signal may be generated with a DC offset level based upon the offset signal, and the modulator adjusts the pulse signal by comparing the error signal to an oscillating signal. As illustrated in FIG. 3, a circuit 300 may include a detector 310, a modulator 320, a switch 330, and a stabilizer 340, along with other components similar to the components of circuit 100 in FIG. 1.

The detector 310 may detect current supplied to an output of the circuit 300 to generate an overcurrent signal. The modulator 320 may modulate a pulse signal based upon the output of the circuit 300. The switch 330 may control a power stage 350 to generate the output of the circuit 300 based upon the overcurrent signal and the pulse signal. The stabilizer 340 may send an offset signal to the modulator 320. The stabilizer 340 may generate the offset signal with a magnitude adjusted based upon the overcurrent signal, and the modulator 320 may adjust the pulse signal based upon the offset signal.

The detector 310 may include a current sensing resistor 312 and an overcurrent comparator 314 that generates the overcurrent signal (Voc) based upon comparison of a signal from the current sensing resistor 312 and a current threshold.

The modulator 320 may include an amplifier 322 that generates an error signal (Vcomp) based upon difference between the output (Output Voltage) of the circuit and an output threshold (Reference Voltage), and a comparator 324 that generates the pulse signal (Vpwm) by comparing the error signal (Vcomp) and an oscillating signal (Vramp). The modulator 320 may include an oscillator 326 that generates the oscillating signal (Vramp), and a clamp 328 that clamps the error signal between a high and a low clamping level (Vclamph and Vclampl respectively). The oscillating signal from the oscillator 326 may have a sawtooth waveform, a triangular waveform.

The switch 330 may receive the overcurrent signal from the detector 310 and the pulse signal from the modulator 320, and may include a NOR gate 332, a flip-flop 334, and a switching controller 336 to control the power stage 350. The power stage 350 may be controlled by the switch 330, via pulse width modulated (PWM), to channel power from a power supply to generate the output for the circuit 300. That is, the power stage 350 may turn the power supply to the output on and off rapidly, and depending on the amount of time that the power supply was on, cause adjustment the output voltage and current. The power stage 350 may include a plurality of gates or switches, capacitors, resistors, inductors, etc. (not shown).

The stabilizer 340 may be connected to the amplifier 322 to generate the error signal that includes the DC offset level. That is, the stabilizer 340 may receive the Reference Voltage signal and add the offset signal (V2) to the Reference Voltage signal to generate a shifted reference voltage signal that shifts its values according to the offset signal, which causes the resulting error signal (Vcomp) to be shifted based upon the offset signal.

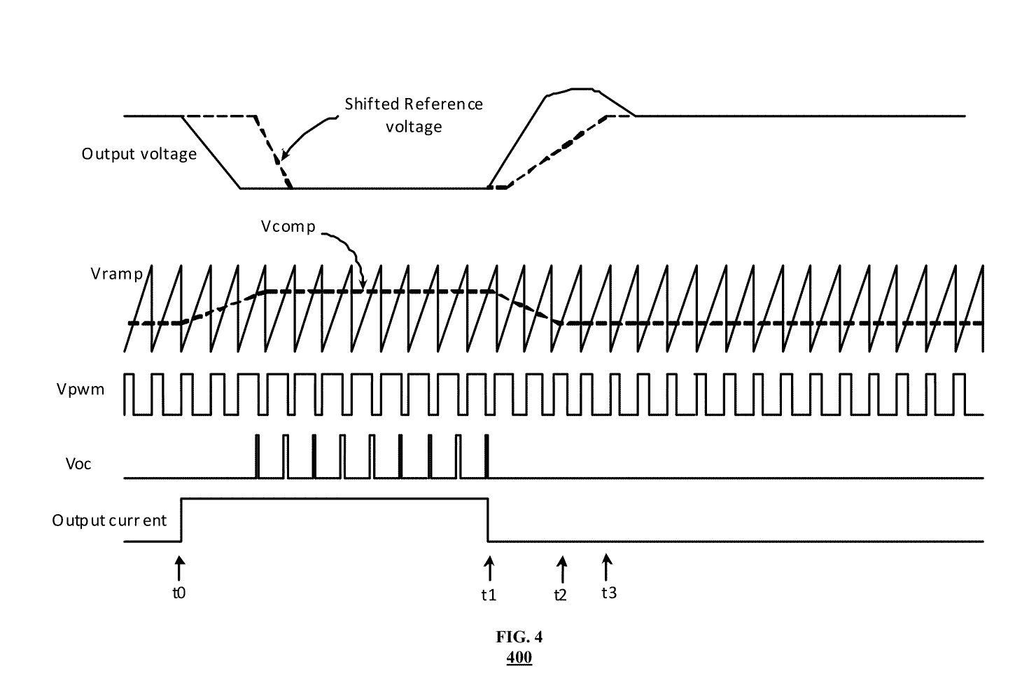

As illustrated in FIG. 4, the offset signal (V2) may be added with the Reference Voltage signal. This may make the Reference Voltage signal track with the Vcomp signal, when Vcomp is going high during large output current drawn.

As shown in FIG. 4, when large output current is drawn at time t0, the Vcomp signal may rise up relative to the Vramp signal. As Vcomp rises, the comparator 324 in modulator 320 may increase the duty cycle of the pulse signal (Vpwm). The switch 330 may control the power stage 350 to provide more power to the output in each cycle. After some delay time, the detector 310 may detect that the current supplied to the output is above the current threshold, and the detector 310 may output the overcurrent signal (Voc) to be high. Shortly after, as the power stage 350 is turned off in a cycle, Voc may return to low.

As the pulse signal (Vpwm) increases in duty cycle, more current may be supplied to the output and Voc becomes activated in each cycle. The stabilizer 340 may measure Voc and increase the magnitude of the offset signal (V2, a negative signal) proportional to the activity of Voc. For example, more Voc high state in a previous period of time, the lower V2 may be adjusted to. The Shifted Reference Voltage signal may shift according to V2 and decrease. This causes the error signal (Vcomp) to continue to rise, but prevents Vcomp from rising above the peak value of the Vramp signal. This may allow the duty cycle of Vpwm to increase as needed, but prevents the overcurrent condition from causing the duty cycle to max out. In steady state, even if the output voltage has already been pulled down below the reference voltage, the duty cycle of Vpwm may be kept at some stable level to make the supply current equal to the current threshold. Thus, the PWM loop of circuit 300 may still be stable at overcurrent condition, even if the output voltage is no longer regulated to desired level.

As illustrated in FIG. 4, when the output current decreases to small value at time t1, the output voltage may begin to rise. Since the Shifted Reference Voltage signal has been shifted lower, the output voltage quickly becomes higher than the Shifted Reference Voltage after time t1, the Vcomp signal start to decrease relative to the Vramp signal, causing Vpwm to reduce in duty cycle. As supply current is decreased, Voc signal stop activating. The stabilizer 340 may reduce the magnitude of the offset signal (V2) according to decrease in Voc signal activities. The Vcomp signal may decrease in its offset. When the Vcomp signal goes back to the original value at t2, the duty cycle of Vpwm may stabilize at some minimum level.

Because of the stabilizer 340, the duty cycle of Vpwm may start to decrease from t1. The circuit 300 may recover from an overcurrent condition quickly. Therefore, the stabilizer 340 in circuit 300 may reduce the over shoot voltage at output.

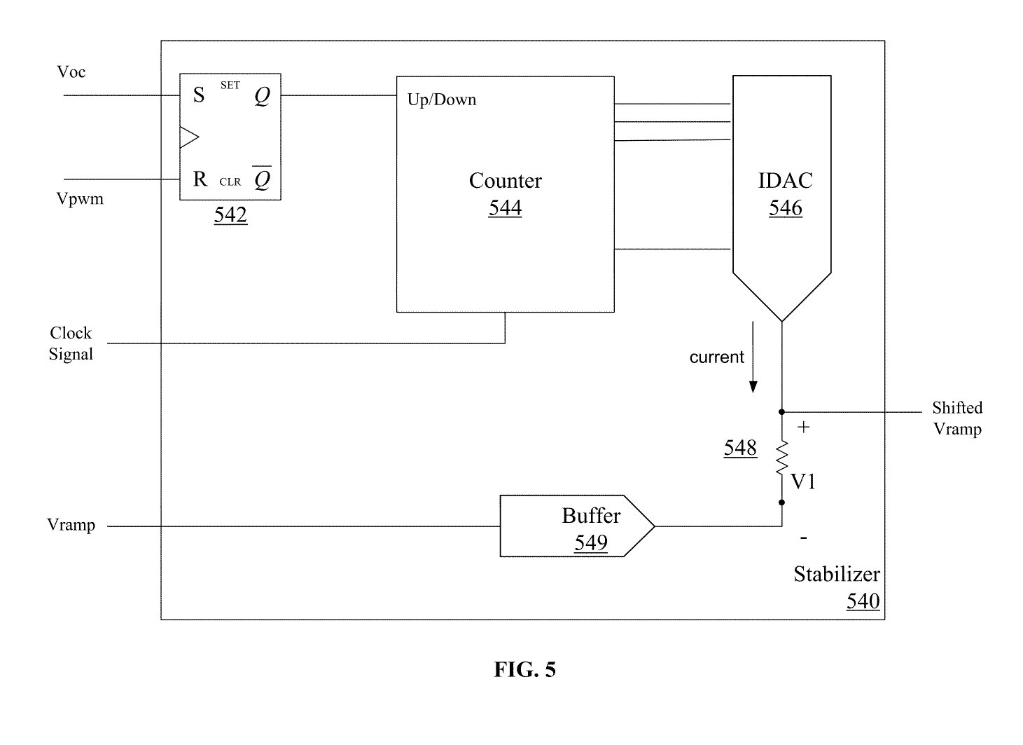

FIG. 5 illustrates a stabilizer 540 that may be used in circuit 100 of FIG. 1. The stabilizer 540 may receive the overcurrent signal and the pulse signal, and may adjust the magnitude of the offset signal as proportional to a value from the counter representing the activities of the overcurrent signal. The stabilizer 540 may adjust the magnitude of the offset signal by measuring the overcurrent signal.

The stabilizer 540 may include a RS-flip-flop 542, a counter 544, a current mode digital-analog converter (IDAC) 546, a pull up resistor 548, and a buffer 549. The RS-flip-flop 542 may receive Vpwm and Voc signals. Vpwm may reset the RS-flip-flop 542 output at a rising edge. Activate Voc signal may set the RS-flip-flop output to high. Since generally Voc signal goes high after Vpwm has turned on supply current for a time period, when Voc signal is active, the RS-flip-flop 542 output is set to high once each clock period, before the falling edge of Vpwm.

The counter 544 may receive the output of RS-flip-flop 542 and a clock signal. The clock signal may be set to trigger the counter 544 to either count up or count down once each clock period of clock, the triggering may be synchronized to near or at the falling edge of Vpwm. In doing so, if Voc is at high state, RS-flip-flop 542 would be outputting high when the clock signal triggers counter 544, which may cause the counter 544 to count up or increase the its counter value by one increment. If Voc is at low state, RS-flip-flop 542 would be outputting low when the clock signal triggers counter 544, which may cause the counter 544 to count down or decrease the its counter value by one increment. The counter 544 may be limited to count up to a maximum value, and limited to count down to a minimum value.

The IDAC 546 may receive the counter value from counter 544 and generate a current signal with a magnitude based upon the counter value, which may be forced through pull up resistor 548 to buffer 549, to generate an offset signal with a magnitude based upon the counter value between the opposite ends of the pull up resistor 548. The buffer 549 may transfer the Vamp signal to one end of the pull up resistor 548, and the pull up resistor 548 along with IDAC 546 adds the offset signal's voltage level (V1) to Vramp to generate the Shifted Vramp. In this fashion, the stabilizer 500 may adjust or shift the Vramp signal based upon measuring the activity of the overcurrent signal Voc.

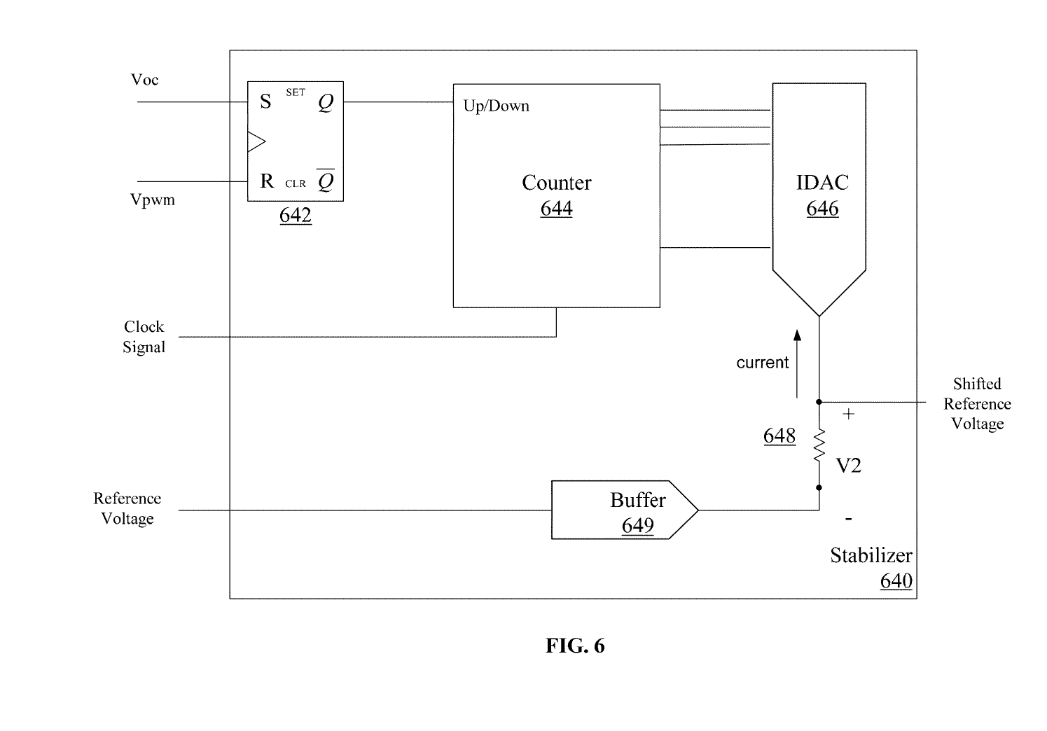

FIG. 6 illustrates a stabilizer 640 that may be used in circuit 300 of FIG. 3. The stabilizer 640 may receive the overcurrent signal and the pulse signal, and may adjust the magnitude of the offset signal as proportional to a value from the counter representing the activities of the overcurrent signal. The stabilizer 640 may adjust the magnitude of the offset signal by measuring the overcurrent signal.

The stabilizer 640 may include a RS-flip-flop 642, a counter 644, a current mode digital-analog converter (IDAC) 646, a pull down resistor 648, and a buffer 649. The RS-flip-flop 642 may receive Vpwm and Voc signals. Vpwm may reset the RS-flip-flop 642 output at a rising edge. Activate Voc signal may set the RS-flip-flop output to high. Since generally Voc signal goes high after Vpwm has turned on supply current for a time period, when Voc signal is active, the RS-flip-flop 642 output is set to high once each clock period, before the falling edge of Vpwm.

The counter 644 may receive the output of RS-flip-flop 642 and a clock signal. The clock signal may be set to trigger the counter 644 to either count up or count down once each clock period of clock, the triggering may be synchronized to near or at the falling edge of Vpwm. In doing so, if Voc is at high state, RS-flip-flop 642 would be outputting high when the clock signal triggers counter 644, which may cause the counter 644 to count up or increase the its counter value by one increment. If Voc is at low state, RS-flip-flop 642 would be outputting low when the clock signal triggers counter 644, which may cause the counter 644 to count down or decrease the its counter value by one increment. The counter 644 may be limited to count up to a maximum value, and limited to count down to a minimum value.

The IDAC 646 may receive the counter value from counter 644 and generate a current signal with a magnitude based upon the counter value, which may be forced through pull down resistor 648 from buffer 649, to generate a negative offset signal with a magnitude based upon the counter value between the opposite ends of the pull down resistor 648. The buffer 649 may transfer the Reference Voltage signal to one end of the pull down resistor 648, and the pull down resistor 648 along with IDAC 646 adds the negative offset signal's voltage level (V2) to the Reference Voltage signal to generate the Shifted Reference Voltage signal. In this fashion, the stabilizer 600 may adjust or shift the Reference Voltage signal based upon measuring the activity of the overcurrent signal Voc.

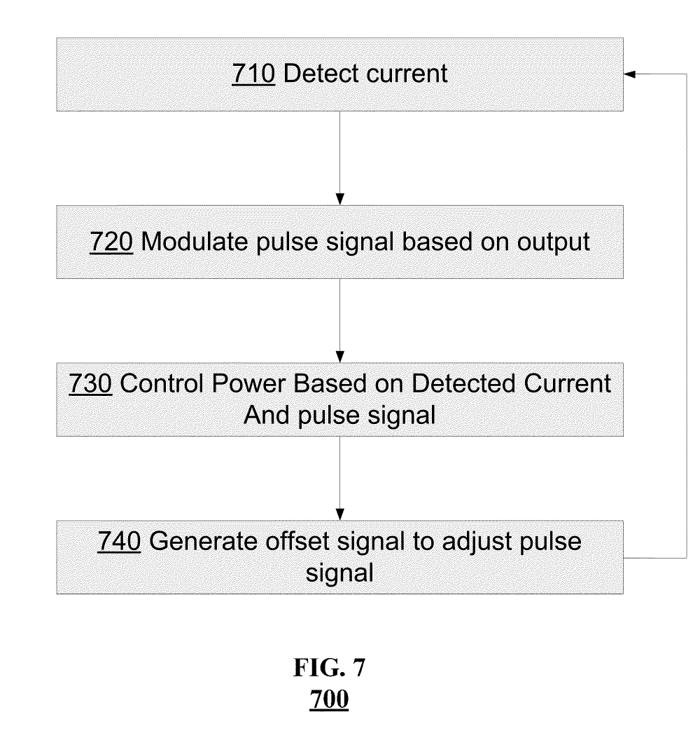

FIG. 7 illustrates a method 700 according to an embodiment.

Method 700 may include block 710, the detector 110 may detect current supplied to an output of the circuit 100 to generate an overcurrent signal.

At block 720, the modulator 120 may modulate a pulse signal based upon the output of the circuit 100.

At block 730, the switch 130 may control a power stage 150 to generate the output of the circuit 100 based upon the overcurrent signal and the pulse signal.

At block 740, the stabilizer 140 may send an offset signal to the modulator 120. The stabilizer 140 may generate the offset signal with a magnitude adjusted based upon the overcurrent signal, and the modulator 120 may adjust the pulse signal based upon the offset signal.

It is appreciated that the disclosure is not limited to the described embodiments, and that any number of scenarios and embodiments in which conflicting appointments exist may be resolved.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather the disclosure extends to all functionally equivalent structures, methods, and uses such as are within the scope of the appended claims.

While the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof.

The present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “disclosure” merely for convenience and without intending to voluntarily limit the scope of this application to any particular disclosure or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

We claim:

1. A circuit, comprising:
a detector detecting current supplied to an output of the circuit to generate an overcurrent signal;
a modulator modulating a pulse signal based upon the output of the circuit;
a switch controlling a power stage to generate the output of the circuit based upon the overcurrent signal and the pulse signal; and
a stabilizer sending an offset signal to the modulator,
wherein the stabilizer generates the offset signal with a magnitude adjusted based upon the overcurrent signal, and the modulator adjusts the pulse signal based upon the offset signal.

2. The circuit according to claim 1, wherein an oscillating signal is generated with a DC offset level based upon the offset signal, and the modulator adjusts the pulse signal by comparing the oscillating signal to an error signal.

3. The circuit according to claim 1, wherein an error signal is generated with a DC offset level based upon the offset signal, and the modulator adjusts the pulse signal by comparing the error signal to an oscillating signal.

4. The circuit according to claim 1, wherein the detector generates the overcurrent signal based upon a current threshold.

5. The circuit according to claim 1, wherein the stabilizer adjusts the magnitude of the offset signal by measuring the overcurrent signal.

6. The circuit according to claim 1, wherein the stabilizer comprises a counter that counts activities of the overcurrent signal and the stabilizer adjusts the magnitude of the offset signal as proportional to a value from the counter representing the activities of the overcurrent signal.

7. The circuit according to claim 1, wherein the modulator comprises an amplifier that generates an error signal based upon difference between the output of the circuit and an output threshold, and a comparator that generates the pulse signal by comparing the error signal and an oscillating signal.

8. A method for controlling a circuit, comprising:
detecting, by a detector, current supplied to an output of the circuit to generate an overcurrent signal;
modulating, by a modulator, a pulse signal based upon the output of the circuit;
controlling, by a switch, a power stage to generate the output of the circuit based upon the overcurrent signal and the pulse signal; and
sending, by a stabilizer, an offset signal to the modulator,
wherein the stabilizer generates the offset signal with a magnitude adjusted based upon the overcurrent signal, and the modulator adjusts the pulse signal based upon the offset signal.

9. The method according to claim 8, wherein an oscillating signal is generated with a DC offset level based upon the offset signal, and the modulator adjusts the pulse signal by comparing the oscillating signal to an error signal.

10. The method according to claim 8, wherein an error signal is generated with a DC offset level based upon the offset signal, and the modulator adjusts the pulse signal by comparing the error signal to an oscillating signal.

11. The method according to claim 8, wherein the detector generates the overcurrent signal based upon a current threshold.

12. The method according to claim 8, wherein the stabilizer adjusts the magnitude of the offset signal by measuring the overcurrent signal.

13. The method according to claim 8, wherein the stabilizer comprises a counter that counts activities of the overcurrent signal and the stabilizer adjusts the magnitude of the offset signal as proportional to a value from the counter representing the activities of the overcurrent signal.

14. The method according to claim 8, wherein the modulator comprises an amplifier that generates an error signal based upon difference between the output of the circuit and an output threshold, and a comparator that generates the pulse signal by comparing the error signal and an oscillating signal.

15. A non-transitory computer readable medium storing computer program instructions, executable by a processor to control a circuit to perform:
detecting, by a detector, current supplied to an output of the circuit to generate an overcurrent signal;
modulating, by a modulator, a pulse signal based upon the output of the circuit;
controlling, by a switch, a power stage to generate the output of the circuit based upon the overcurrent signal and the pulse signal; and
sending, by a stabilizer, an offset signal to the modulator,
wherein the stabilizer generates the offset signal with a magnitude adjusted based upon the overcurrent signal, and the modulator adjusts the pulse signal based upon the offset signal.

16. The non-transitory computer readable medium according to claim 15, wherein an oscillating signal is generated with a DC offset level based upon the offset signal, and the modulator adjusts the pulse signal by comparing the oscillating signal to an error signal.

17. The non-transitory computer readable medium according to claim 15, wherein an error signal is generated with a DC offset level based upon the offset signal, and the modulator adjusts the pulse signal by comparing the error signal to an oscillating signal.

18. The non-transitory computer readable medium according to claim 15, wherein the detector generates the overcurrent signal based upon a current threshold.

19. The non-transitory computer readable medium according to claim 15, wherein the stabilizer adjusts the magnitude of the offset signal by measuring the overcurrent signal.

20. The non-transitory computer readable medium according to claim 15, wherein the stabilizer comprises a counter that counts activities of the overcurrent signal and the stabilizer adjusts the magnitude of the offset signal as proportional to a value from the counter representing the activities of the overcurrent signal.
